(19) United States
(12) Patent Application Publication
(10) Pub. No.: US 2022/0283630 A1
(43) Pub. Date: Sep. 8, 2022

(54) ELECTRONIC HEAD-GEAR AND CLOTHING

(71) Applicant: DILLON JAMES KORPMAN, NASHVILLE, TN (US)

(72) Inventor: DILLON JAMES KORPMAN, NASHVILLE, TN (US)

(21) Appl. No.: 17/685,868

(22) Filed: Mar. 3, 2022

Related U.S. Application Data
(60) Provisional application No. 63/284,417, filed on Nov. 30, 2021.
(60) Provisional application No. 63/229,712, filed on Aug. 5, 2021.
(60) Provisional application No. 63/217,986, filed on Jul. 2, 2021.
(60) Provisional application No. 63/155,807, filed on Mar. 3, 2021.

(51) Int. Cl. G06F 3/01

(52) U.S. Cl. CPC G06F 3/011

(57) ABSTRACT

A graphic identity clothing systems, including a fully electronic mask, helmet, or other form of head-gear and corresponding, coordinated electronic clothing. The mask partially or entirely encloses or encompasses the head (with an opening for the neck). While the mask or helmet may be worn and used by itself, it also may be incorporated with electronic or electronically-enhanced clothing, costumes, apparel, and/or accessories. The graphic or digital appearance of the various items may be coordinated in various pre-set configurations or “skins,” which can be changed on the fly by a mobile device application. A user can use an application to create and develop skins as NFT digital assets, which can be used, displayed, traded, bought, and sold. Users may display the NFTs they own or license on their own person by projecting the NFTs on their digital clothing.

This application claims priority to and benefit of U.S. Provisional Applications No. 63/155,807, filed Mar. 3, 2021, No. 63/217,986, filed Jul. 2, 2021, No. 63/229,712, filed Aug. 5, 2021, and No. 63/284,417, filed Nov. 30, 2021, by Dillon James Korpman, all of which are incorporated herein in their entireties by specific reference for all purposes.

### FIELD OF INVENTION

This invention relates to a fully electronic mask, helmet, or other form of head-gear and clothing.

### SUMMARY OF INVENTION

In various exemplary embodiments, the present invention comprises a fully electronic mask, helmet, or other form of head-gear and corresponding electronic clothing. While the mask or helmet may be worn and used by itself, it also may be incorporated with electronic or electronically-enhanced clothing, costumes, apparel, and/or accessories.

The mask can be programmed to display different colors and effects to provide different looks as part of a “graphic identity.” The mask may be worn with a variety of electronically-enhanced clothing, costumes, apparel or accessories, which may include, but are not limited to, shoes, socks, jackets, shirts, pants, shorts, ties, bracelets, watches, necklaces, rings, jewelry, sunglasses, glasses, bags, backpacks, purses, luggage, belts, chains, scarves, hats, caps, cuff links, dresses, skirts, furniture, sweaters, hoodies, sweatshirts, underwear, lingerie, gloves, or other items to which one or more electronic components such as, but not limited to, cameras, video screens, lights, and/or microphones can be attached. In additional embodiments, accessories may also include appliances, furniture and other home or office furnishings (e.g., toasters, refrigerators, ovens, microwaves, chairs, sofas, desks, tables, and the like). Any of the above items may include or comprise one or more microphones, one or more video screens, one or more cameras (e.g., video cameras), one or more light sources, one or more power sources (e.g., batteries), one or more speakers or sound-creating devices, one or more wireless communications chips or devices, and/or one or more microprocessors, CPUs, or processing chips.

In several embodiments, the mask and/or electronically-enhanced clothing, costumes, apparel and/or accessories may be provided with a number of pre-set or pre-established appearances or aesthetic configurations, which can be changed at any time by the user using an application on a mobile computing device, a website on a network (such as the Internet), a separate dedicated control module, or controls on or in the helmet or item. Controls may be physical buttons, sliders or dials (or similar mechanical controls), touchscreen input, or vocal commands, or combinations thereof.

In several embodiments, the mask and electronically-enhanced clothing, costumes, apparel, and/or accessories may be combined to produce a coordinated “graphic identity,” “electronic aesthetic,” or “electronic appearance,” which can be changed by the user as desired. The mask may be in electronic communication, wired or wirelessly, with one or more electronic elements of the clothing, costumes, apparel or accessories. Accordingly, a user can digitally/electronically change his or her appearance or outfit, including any or all of above-described components (e.g., mask, clothing, costume, apparel, accessories) quickly and easily without having to actually change his or her clothes.

Additional digital pre-set appearance or aesthetic configurations (e.g., “skins”) may also be available (such as by purchasing from a website) for downloading and installing on an individual component, or on multiple components. Several such digital pre-sets may be combined together and provided as a partial or entire package, so that a user may purchase or obtain a partial or complete appearance or configuration change. Further, several such configurations may be provided as a “collection.”

In various exemplary embodiments, some or all of the above-described components (e.g., mask, clothing, costume, apparel, accessories) may comprise one or more microphones attached to or incorporated in the item. In several embodiments, the microphones are directed or positioned to pick up ambient or exterior sounds or noise, such as music. One or more screens and/or light elements (e.g., LEDs) on the item may then produce displays that are synchronized with the ambient or exterior music (or sounds). Where the items are part of an electronic appearance/aesthetic, these displays may be synchronized across all components, although the user also may choose to have only some components synchronized, or none of the components synchronized.

Further, each configuration or “collection” created may provide a different “hardset” way to display the one or more digital preset configurations, as described above, subject to the selection and control by the user. That is, the physical material and appearance of the item surrounding or supporting the various digital and/or electronic components (e.g., video screen, light sources, and the like) may vary from item to item, and collection to collection. Certain digital pre-set appearance or aesthetic configurations (“skins”) may only be available for one or more specific collections. In some embodiments, a user could use the digital skin for a certain “hardset” piece from one collection with a different “hardset” piece from a different collection, and thus compare how the skin looks on various hardset pieces. For example, a user may have one style of shoe where the majority of the surface of the shoe could be a video screen display, while a second style of shoe has smaller screen displays and more of a supporting leather component. A digital skin thus would look different depending on which shoe (i.e., which “hardset” item) it was displayed.

In further embodiments, a “collection” may be expanded to include not only items worn, carried, or accompanying the user (e.g., clothing, worn or carried accessories, and the like), but also items in the home or office space of the user, as described above. Digital skins thus can be applied to appliances, furniture, and/or furnishings.

In several further embodiments, the mobile device application may also be interactive with and in response to real-time events, as well as connecting in real-time to other applications. For example, the user may have their “skins” application connected with their preferred weather application on their mobile device (or with another weather application or service that is compatible with the application). The skins or appearance of some or all of the digital clothing items described above could then automatically change to reflect the real-time weather of the immediate location (or, alternatively, with another chosen location). Thus, if the weather is sunny, the clothing skin will change to match the sunny weather with a sunny or other compatible aesthetic (or, alternatively, another aesthetic chosen by the user). Skins may also reflect the user's immediate or chosen location, environment, mood, or events.

In further embodiments, at least some of the skins are interactive with the user when an article clothing is touched. In one embodiment, skins can be uploaded/downloaded across the system's skins platform, with the skins capable of touch-based interaction.

In yet additional embodiments, the skins platform serves as a platform for creating and marketing of skins and related products as NFTs. An NFT (non-fungible token) is a unit of data stored of a digital ledger (e.g., blockchain) that certifies a digital asset to be unique and thus not interchangeable. NFTs can be used to represent items such as photos, videos, audio, digital files, and digital assets. A user can use the skins application to create and develop skins as NFT digital assets, and thus develop a personal or corporate brand. The system may include a marketplace for skins-related NFTs whereby some, if not all, of the NFTs can be displayed, traded, bought, and sold. In addition to the usual online marketplace formats, users may display the NFTs they own on their own person by projecting the NFTs on their digital clothing, as described above. The projected NFTs may be digital art pieces and not necessarily created for the sole purpose of being an NFT skin offered in the platform marketplace In addition, new skins may be considered as NFTs in and of themselves. In one embodiment, an article of digital clothing may be an NFT itself, and may also be used as a means of displaying and showing off the user's collection of NFTs (e.g., digital art pieces) without having to use a computer or mobile computing device to separately display or show the collected NFTs (e.g., digital art pieces).

### BRIEF DESCRIPTION OF THE DRAWINGS

FIG. 1 show a diagram of the exterior of an electronic mask or helmet in accordance with an embodiment of the present invention.

FIG. 2 shows a diagram of the inner layer of the mask of FIG. 1

FIG. 3 shows a graphic identity design conceptual drawing.

FIGS. 4-8 show examples of pre-set aesthetic configurations for a mask in use.

FIG. 9-10 show examples of lights in the interior and on the exterior of the mask of FIG. 1 in use.

FIGS. 11-16 show views of a mask in various stages of construction.

FIG. 17 shows a container for transporting a mask.

FIGS. 18-21 show examples of the mask being worn with corresponding electronic clothing.

FIGS. 22-27 show views of a “spine” or back container unit.

FIGS. 28-36 show elements and construction of a mask or helmet on a mold or interior structure.

FIGS. 37-40 show examples of user interface screens from an application program for electronic clothing.

### DETAILED DESCRIPTION OF EXEMPLARY EMBODIMENTS

In various exemplary embodiments, the present invention comprises a fully electronic mask, helmet, or other form of head-gear and corresponding electronic clothing. The mask partially or entirely encloses or encompasses the head (with an opening for the neck). While the mask or helmet may be worn and used by itself, it also may be incorporated with electronic or electronically-enhanced clothing, costumes, apparel, and/or accessories.

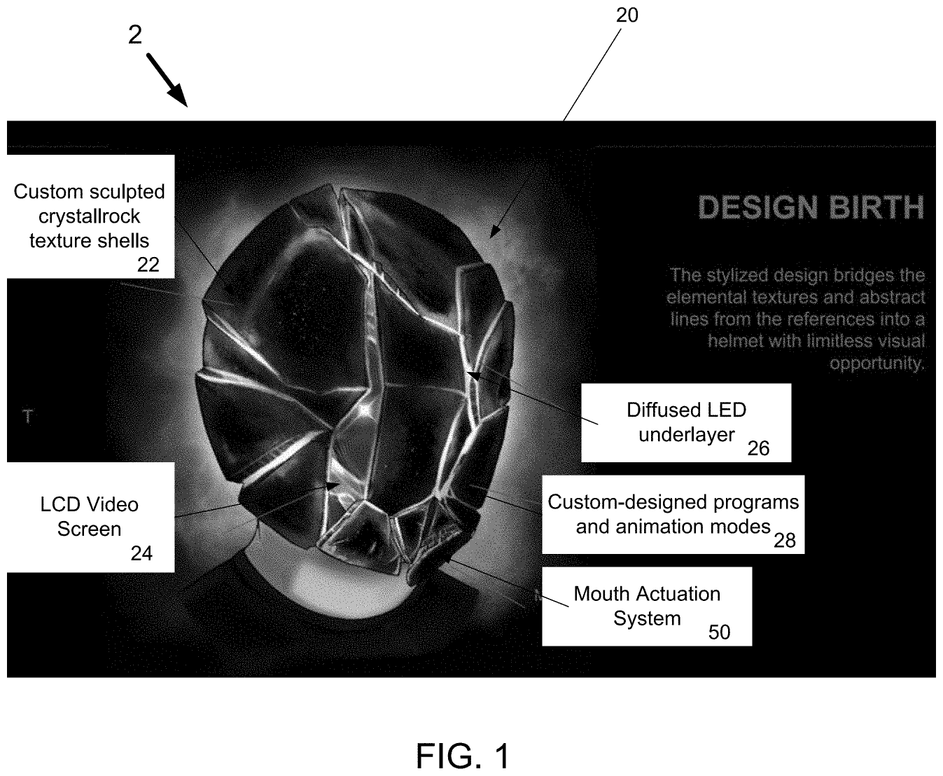

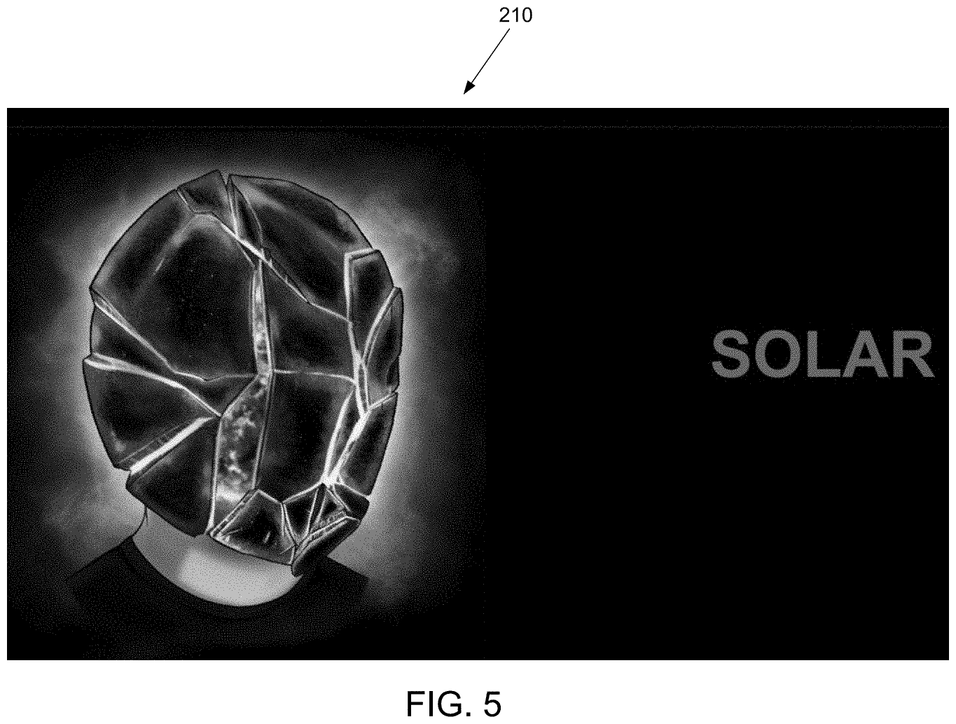

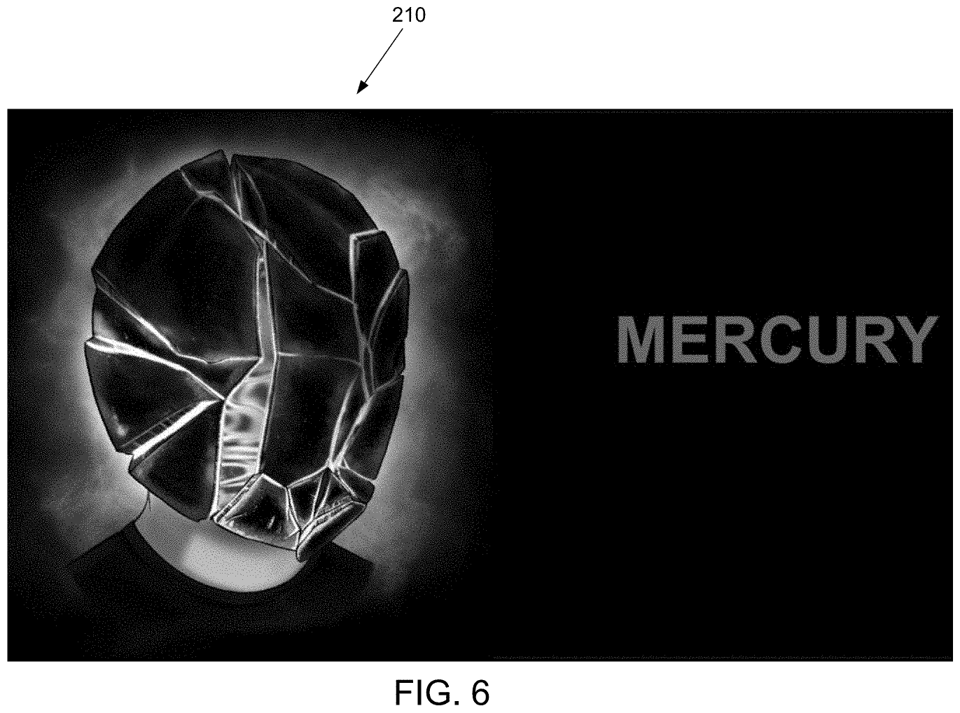

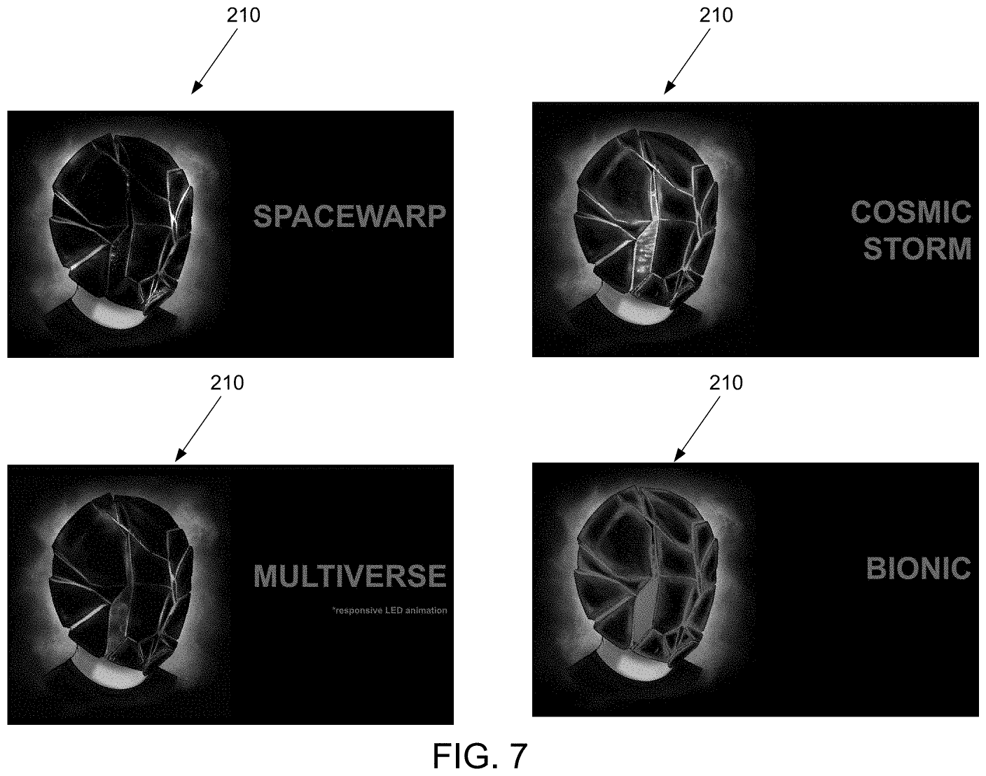

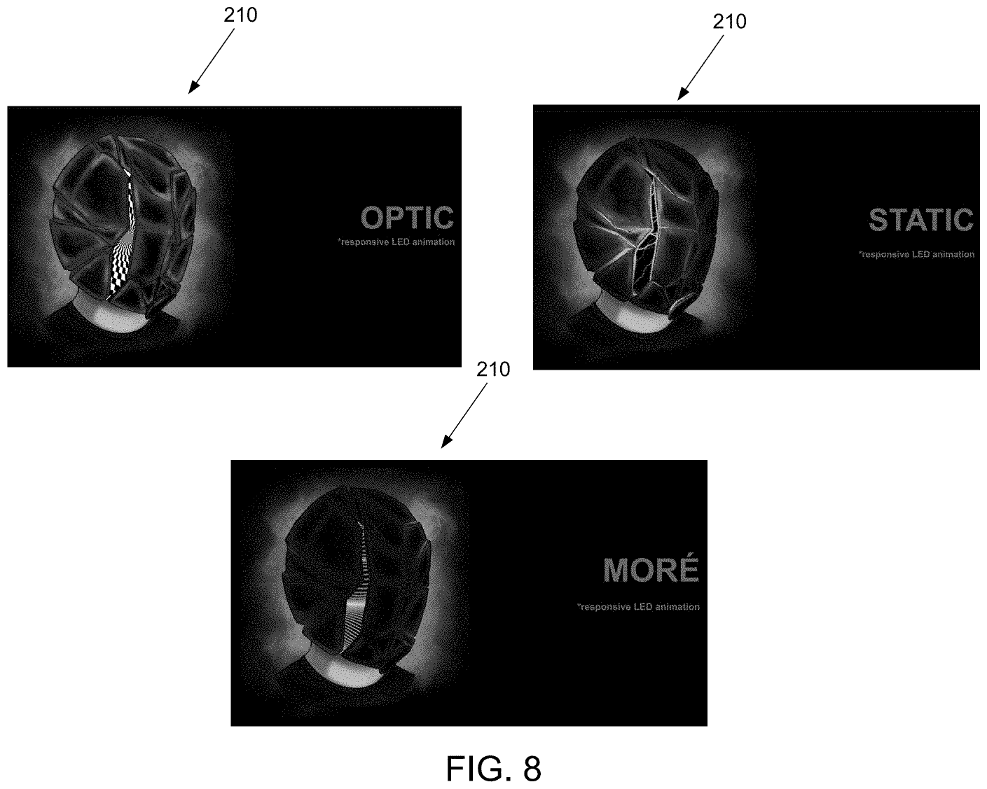

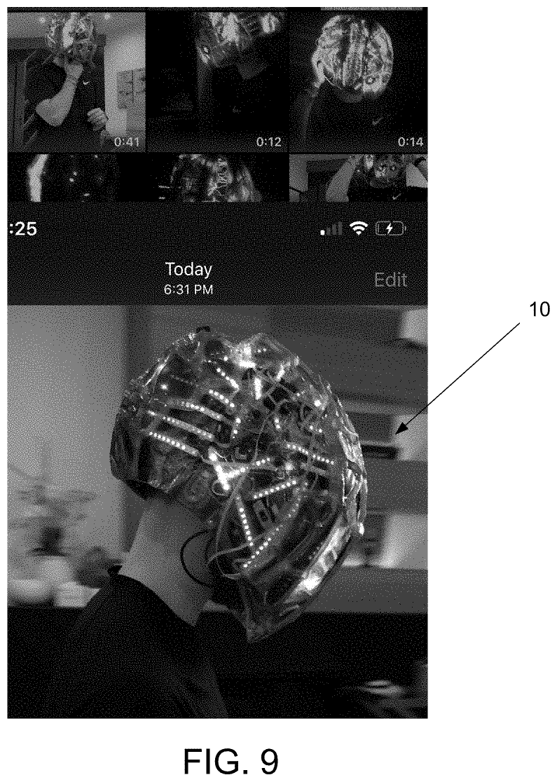

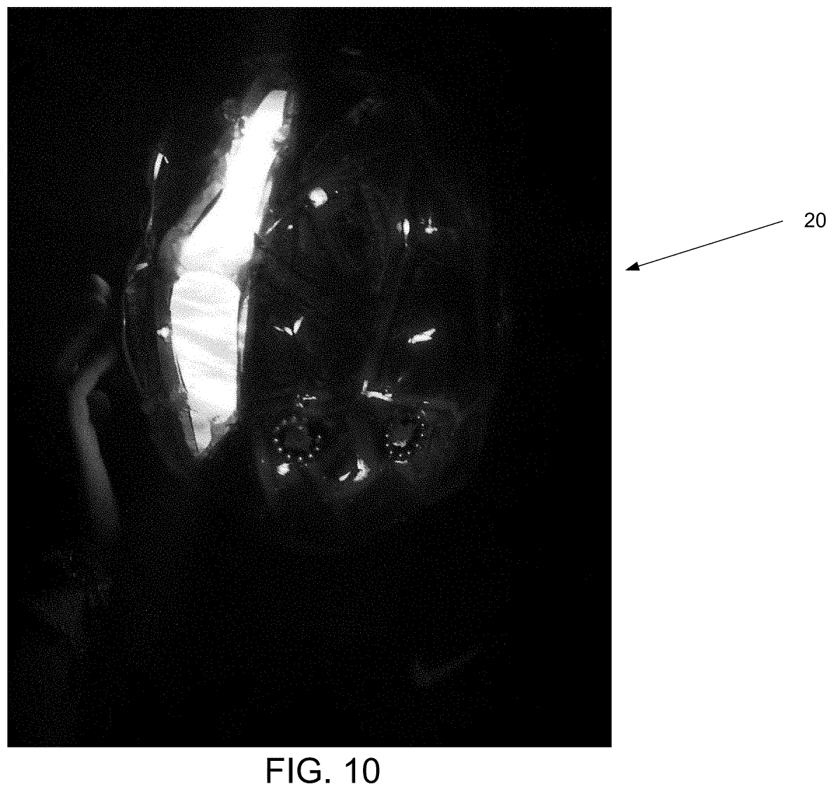

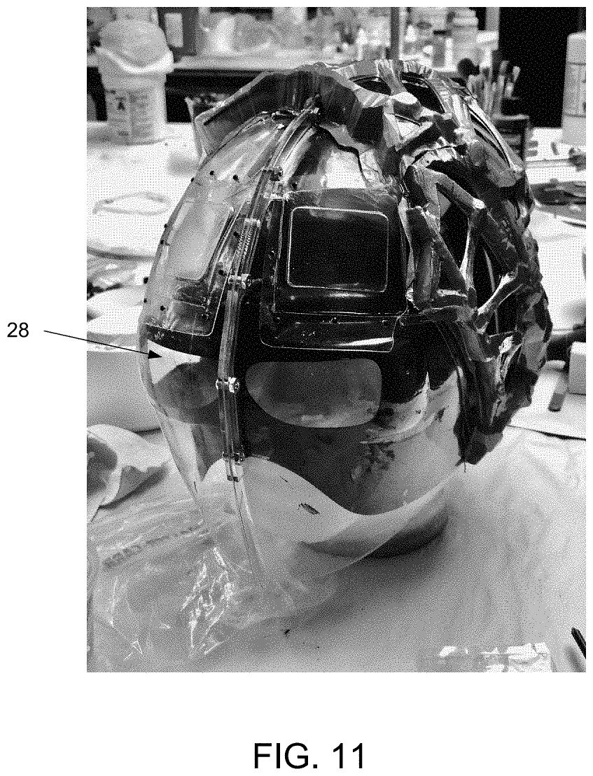

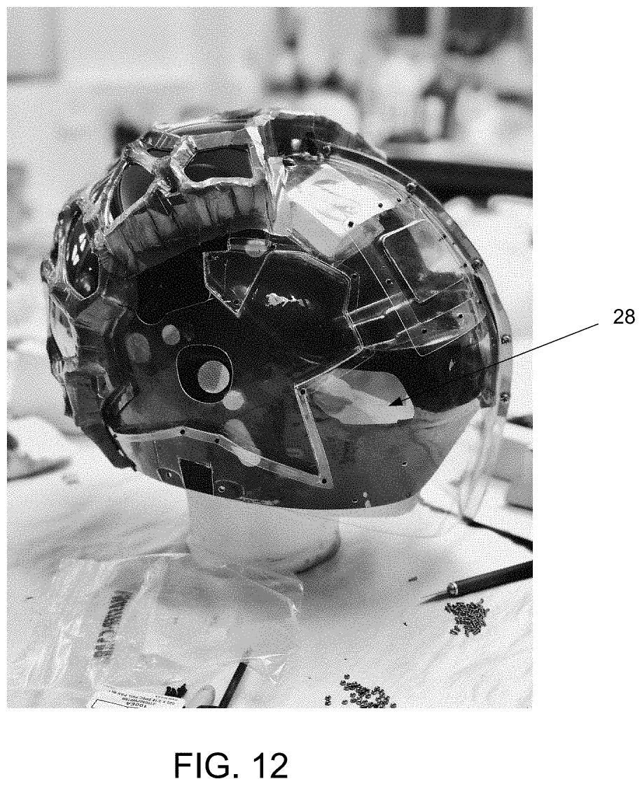

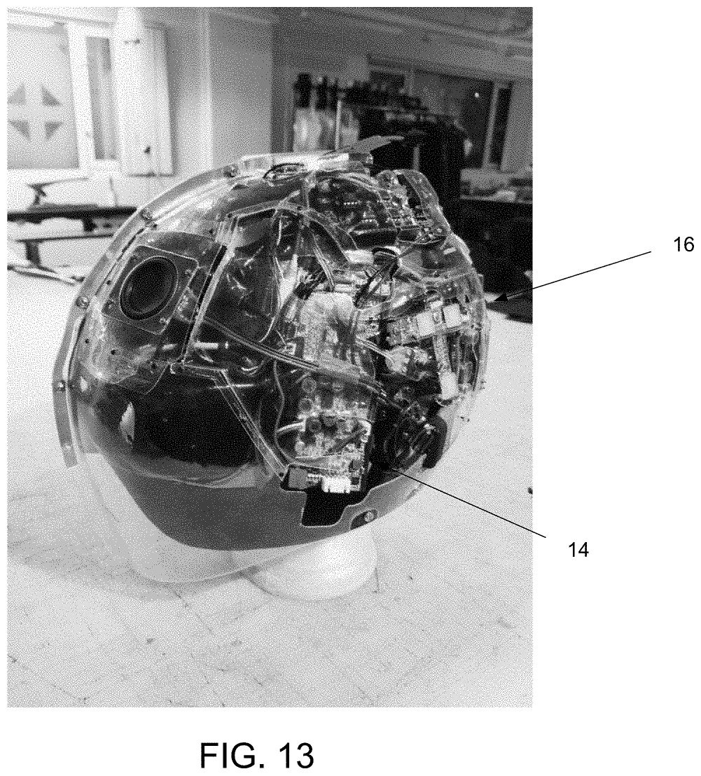

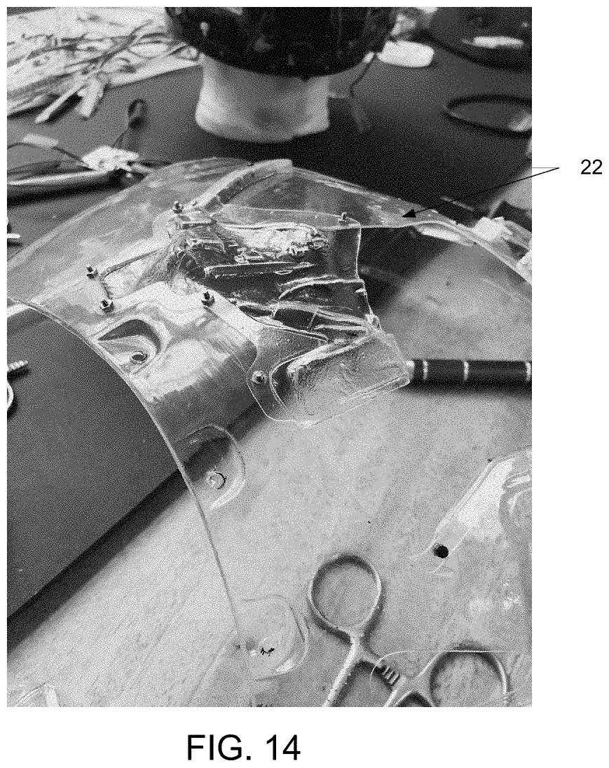

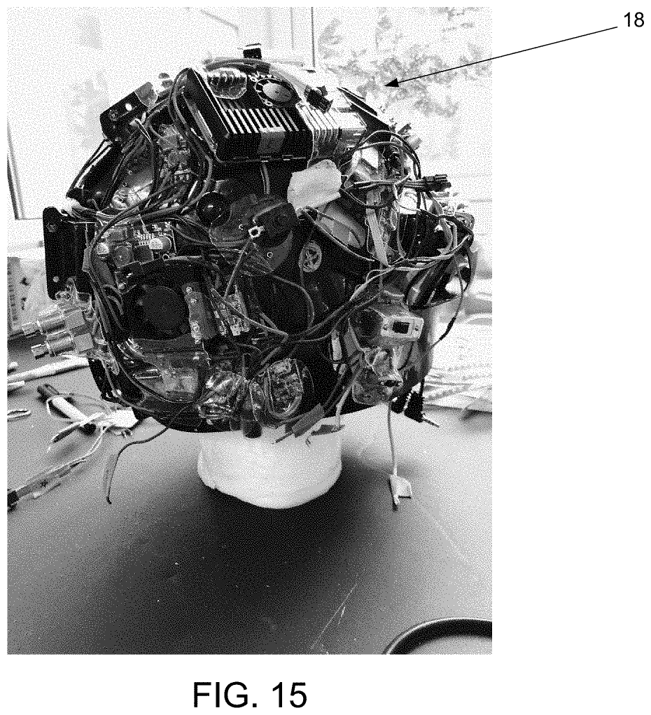

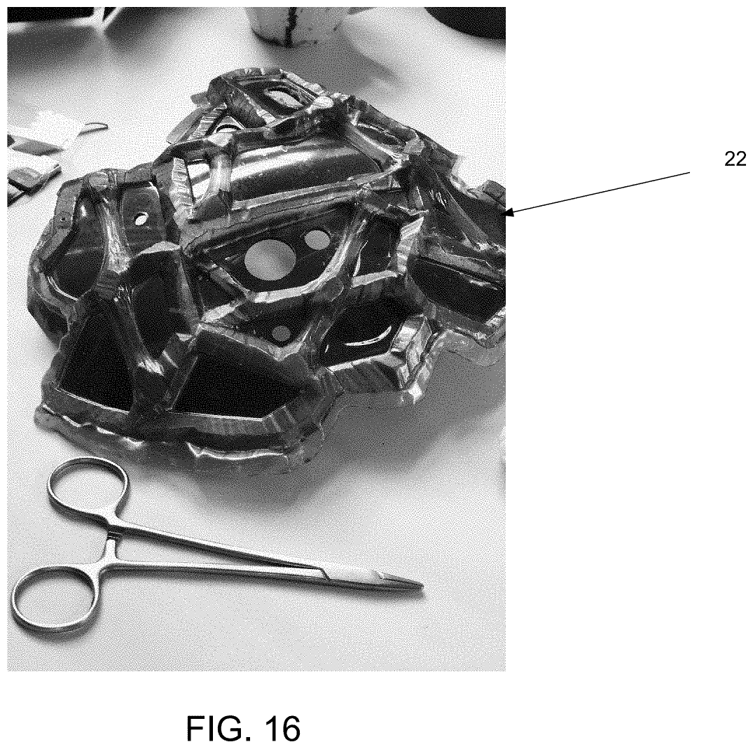

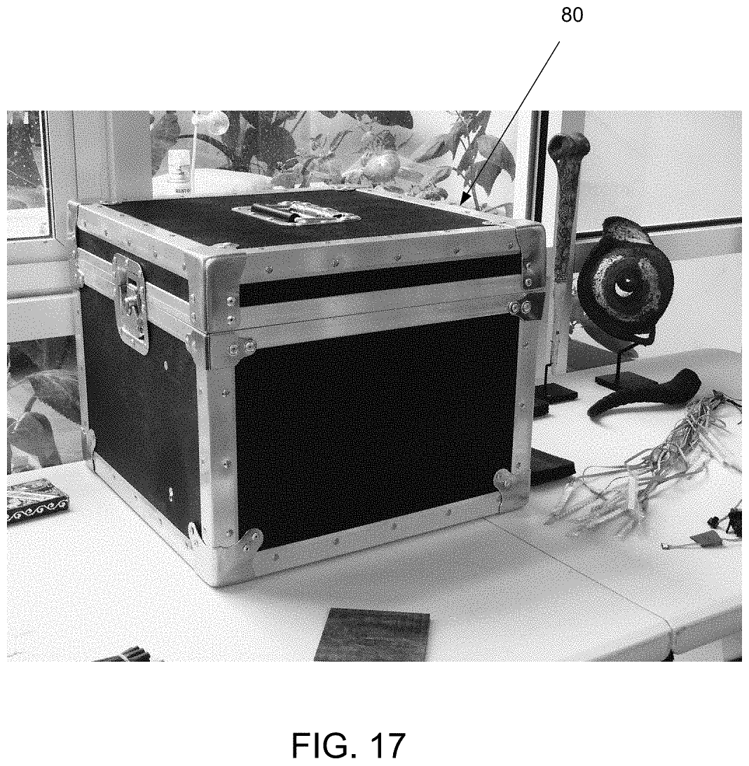

As seen in FIGS. 1-16, the mask (or helmet) 2 comprises an inner layer 10 or set of interior components comprising one or more power sources (e.g., batteries) 12, one or more controller boards 14 with digital storage and one or more microprocessors, and a plurality of light sources 16, such as, but not limited to, LEDs, diodes, infrared diodes, and the like. Fans 18a, b pull air into the interior, and also discharge air out, thereby providing air circulation and ventilation, as described further below. The interior components may be disposed on a hard framework or inner shell, which may be open, and which may be padded in whole or in part.

An outer layer 20 comprises one or more exterior shell components. The shell components comprise a variety of sculpted geometric or polygonal shapes 22, which may be regular or irregular. In several embodiments, the shell components comprise sculpted elemental, crystalline or “crystal-rock” textured shells. These shells may be of different sizes and shapes, but combine together to present an overall fractured appearance, where there are spaces or gaps between adjacent shells. One or more of the shell components may comprise one or more video screens, including, but not limited to, an LCD video screen 24. The LCD video screen may be partially behind adjacent texture shells, so only part of the screen may be seen from the exterior. In several embodiments, the LCD video screen may be a 4K resolution screen (or higher). A diffused LED (or other light source) underlayer 26 provides backlighting from underneath the texture shells 22, which may then be visible through the spaces or gaps between the shells.

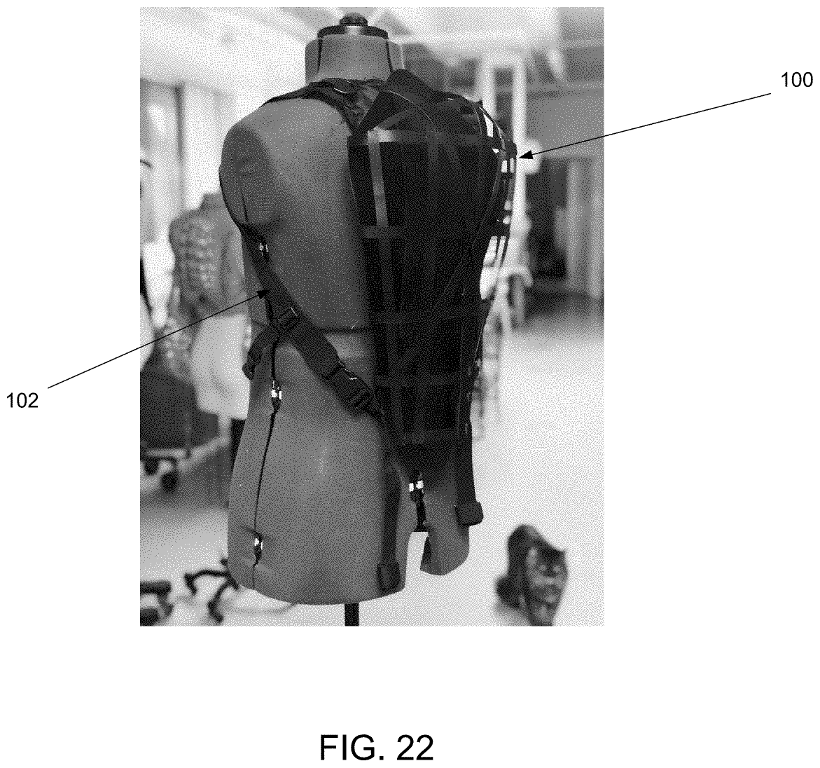

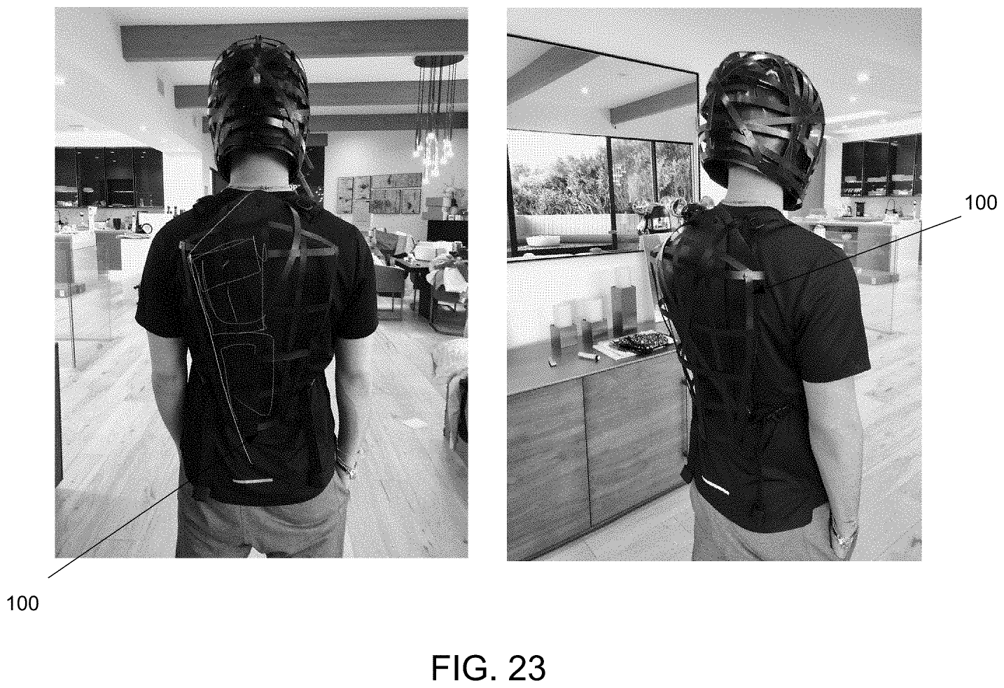

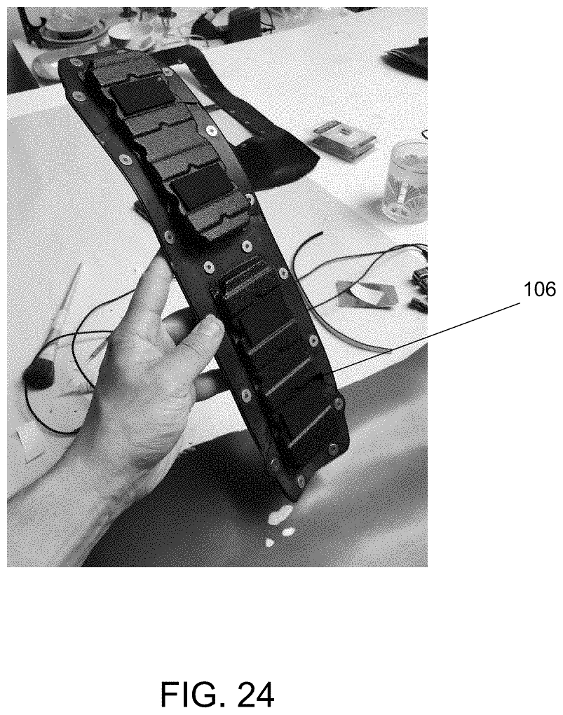

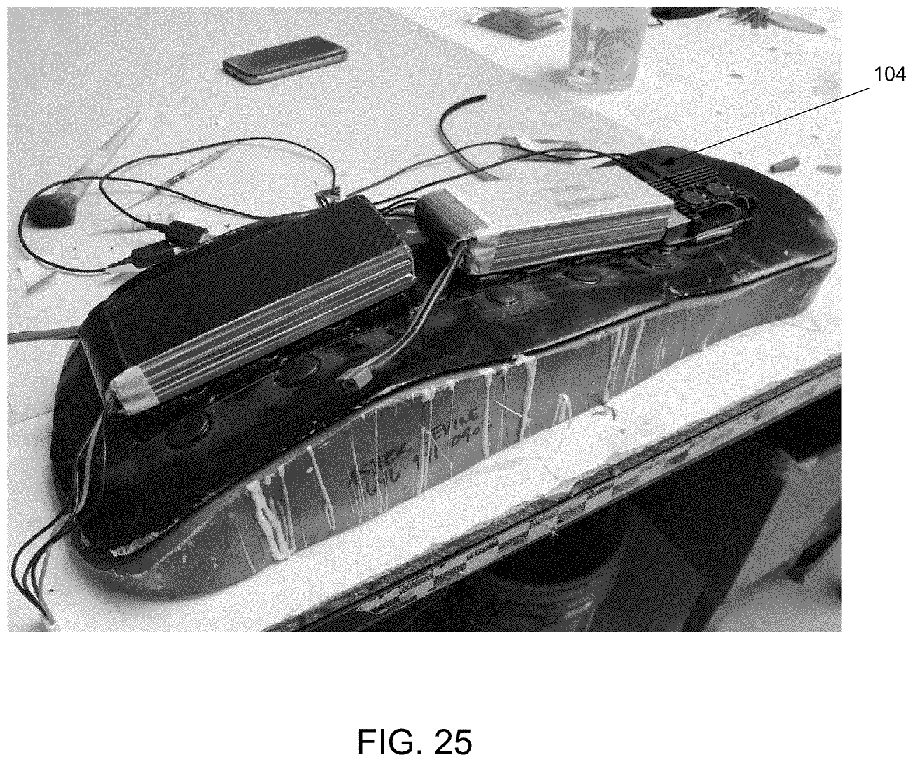

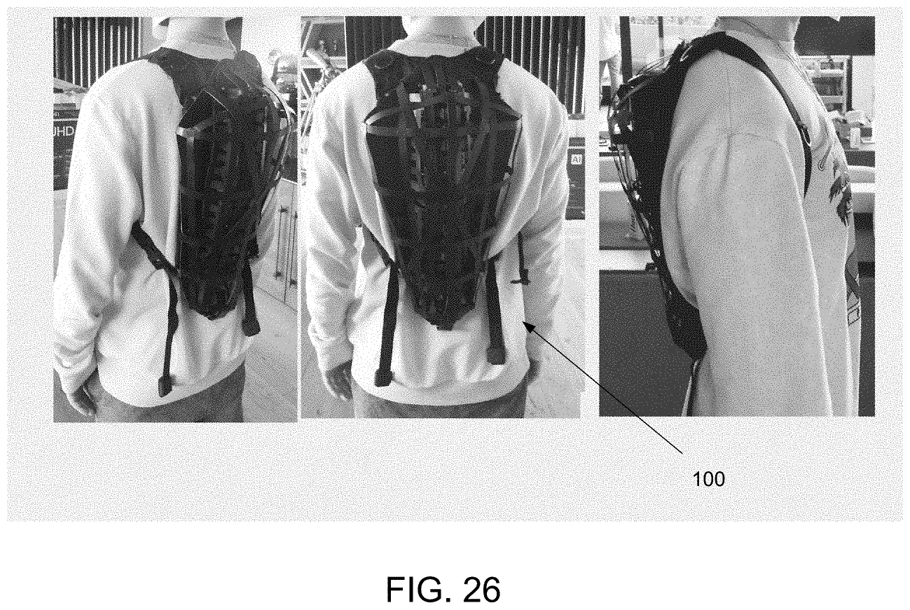

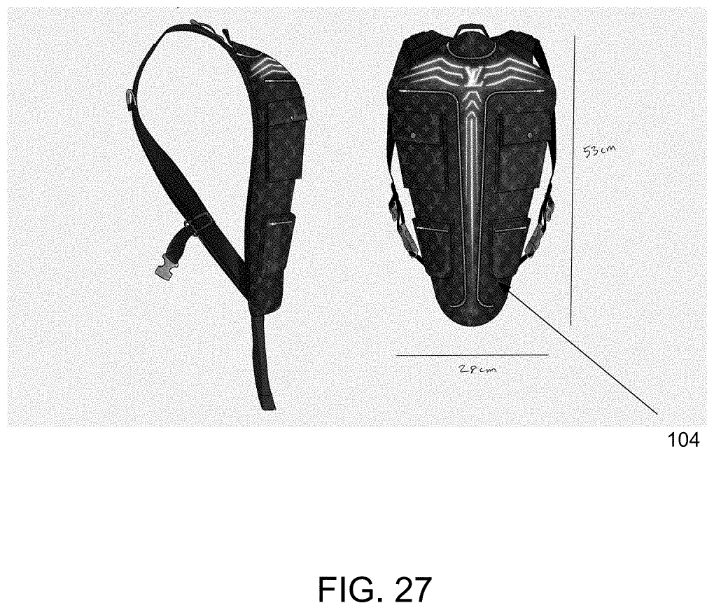

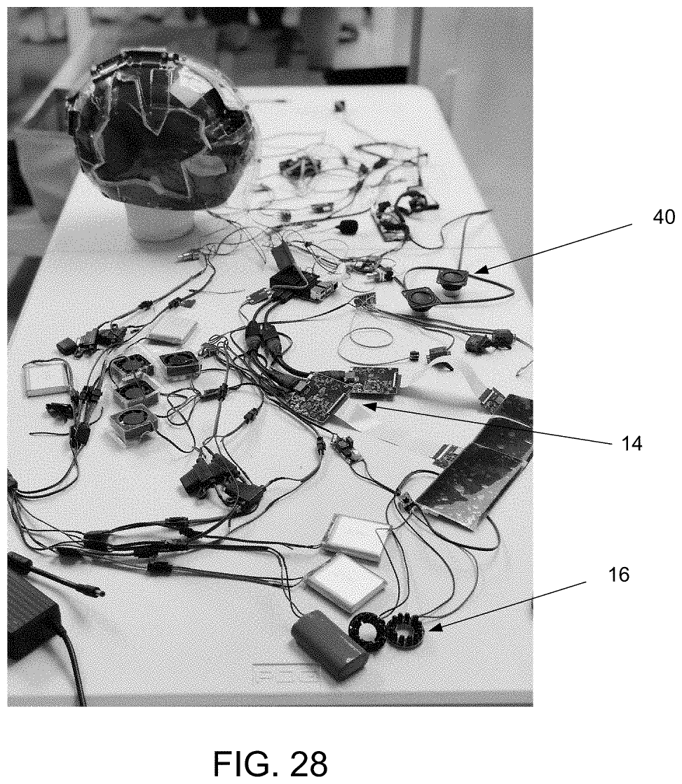

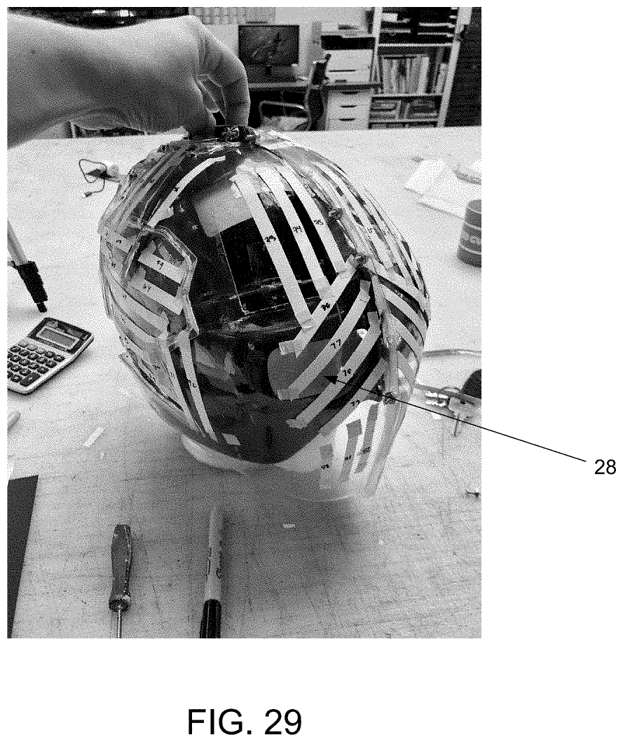

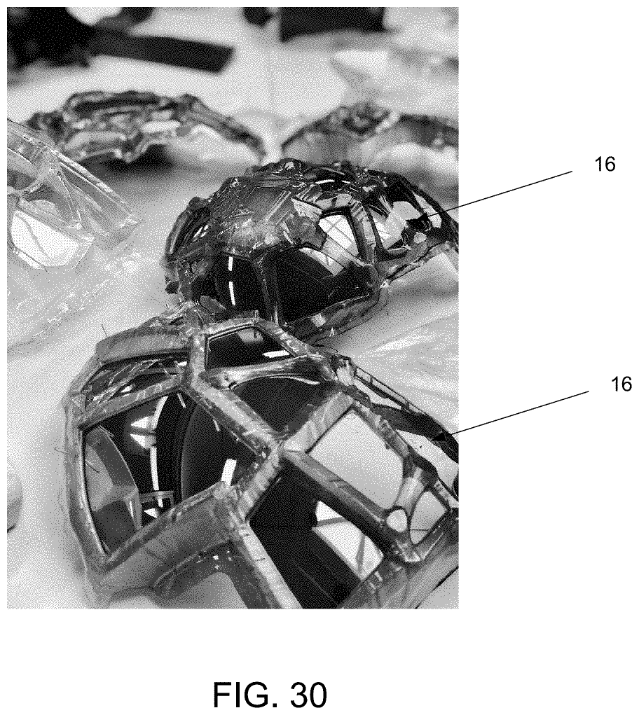

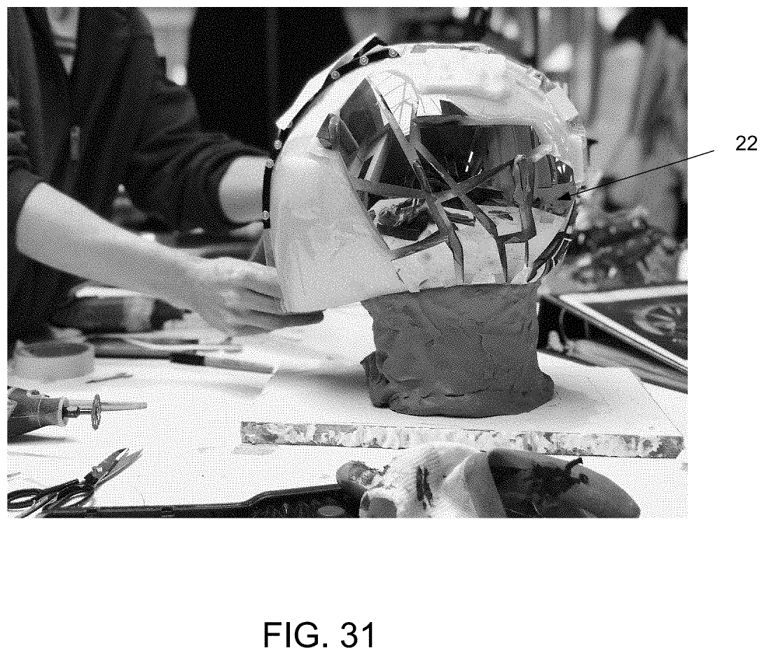

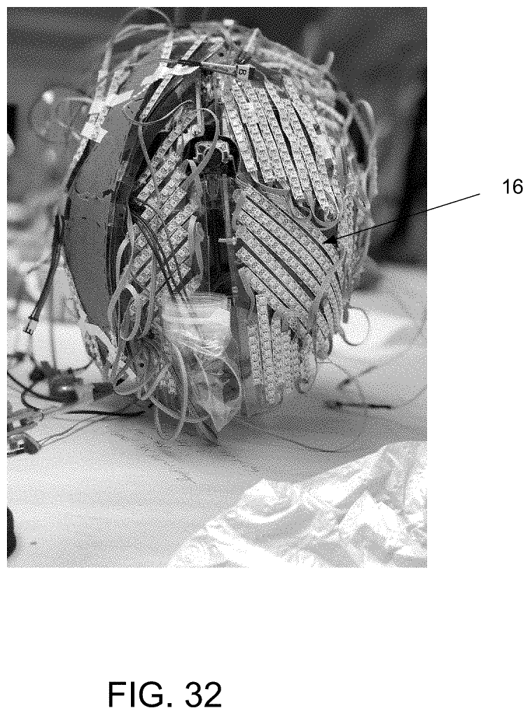

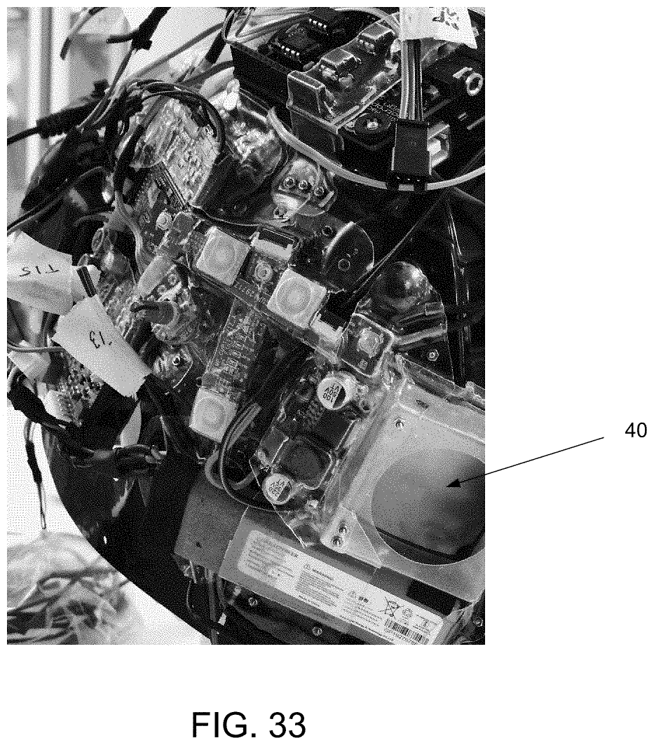

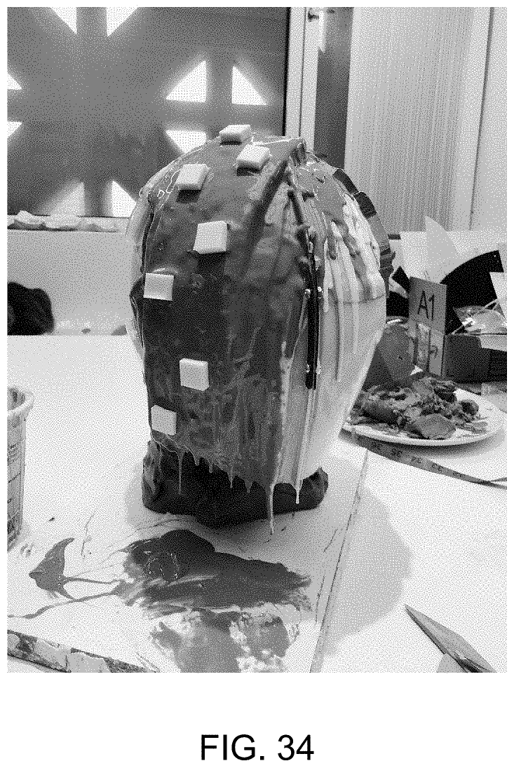

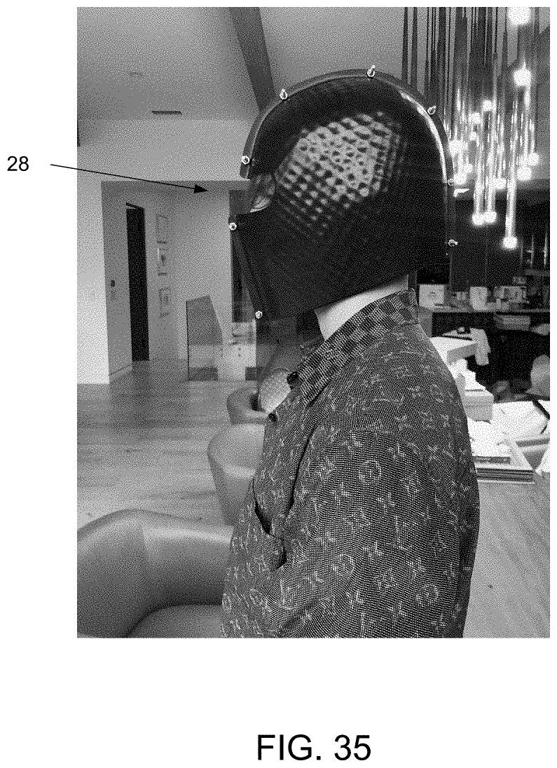

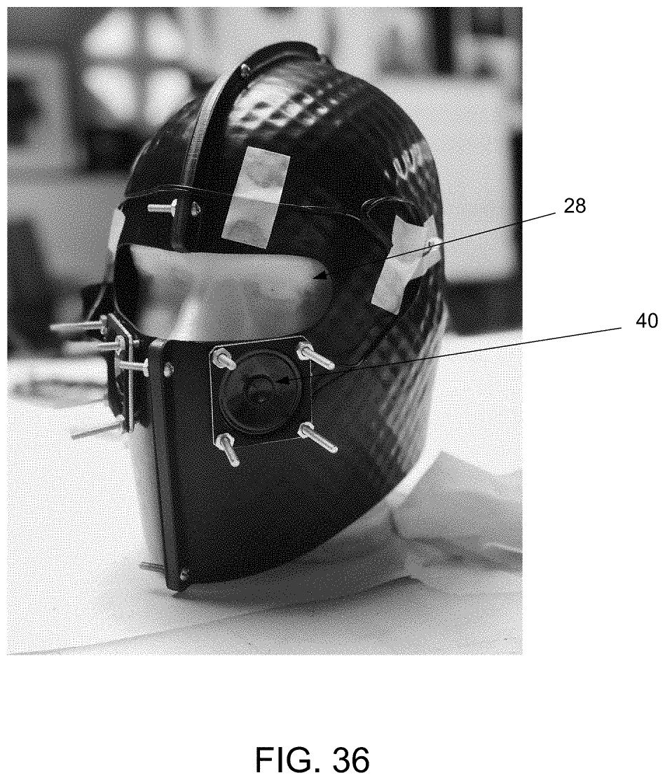

While batteries (which may be rechargeable) or other power source 12 may be located inside the mask, batteries may also be located in an external compartment, container, or “spine” 50. Batteries can be replaced by fully charged batteries, although in several embodiments, batteries in the mask (or other clothing items) may be recharged in place, such as by placing the clothing item in proximity to a charging unit in a drawer, dresser, closet, wardrobe, rack, stand, hanger, or the like, for charging by induction. Other components of the system also may be located in or on the spine or external compartment or container. FIGS. 22-27 show examples of a “spine” unit 100, configured to be worn and positioned on the user's back, held thereon by a harness or straps 102, with the magnetic compartment holding the batteries 106 within the spine, and the spine shell, frame or bag 104.

In several embodiments, one or more of the shell components may be re-arranged or reconfigured in different forms. In some embodiments, one or more of the shell components may be “custom” molded or sculpted, so that different masks may have at least one shell component differing, as well the location or arrangement of the shell components.

One or more of the shells 22 are translucent or transparent, in whole or in part. The controller board(s) 14 contains programs and various animation modes to control the display of lights on various portions of the outer layer shell components 28. Back lighting may be provided by a diffused LED underlayer 26. Static or dynamic light displays (which may use light sources as described above) may be shown or displayed on one, some or all of the shell components. Dynamic light displays may include animation modes.

The mask 2 may comprise one or more spaces 28 where the user can see out of the mask, but a viewer outside cannot see inside the mask when in use (i.e., when lights are displayed), or can only see inside with difficulty. In several embodiments, one or more video cameras 30 are provided on the mask to see forward (or in other directions), and the user views the camera video on an internal electronic viewscreen, which may be in the form of goggles or similar eyewear 32a, or as a headset 32b. In several embodiments, the mask provides night vision or other form of enhanced or modified vision (e.g., telescopic, microscopic, UV-band, infrared, and so on).

In additional embodiments, one or more cameras 30, including video cameras, may be located in or on the mask to record images and events outside the mask (e.g., POV or point-of-view). These cameras may or may not be separate from video cameras used by the user for real-time vision, as described above. Earphones, earbuds, or internal speakers 34 may be provided, along with one or more externally-facing microphones 38. The user may thus be provided with normal or enhanced hearing.

In some embodiments, the mask may have wireless communications capability 32b. In several embodiments, the mask may also be used as a mobile electronic communications device with wireless communication to a network.

While a user may speak normally while wearing a mask, in several embodiments, an internal microphone 42 and/or an external speaker or speaker system 40 is provided to enable the user to speak therethrough, in a normal voice or an electronically-altered or modulated voice. The speaker or speaker system also may be used to play recorded sounds or speech.

In several embodiments, one or more of the shell components may be mobile or moved. For example, one or more of the shell components in the location of the user's mouth may be moved by one or more actuators or mouth actuation system 50 to cause movement of those components (e.g., movement in and out) when the user speaks.

The mask may comprise one or more fans or other forms of air-conditioning.

Some fans may introduce air into the mask 18a, while other fans may remove out of the mask 18b, thereby promoting circulation of fresh, cool air in the mask.

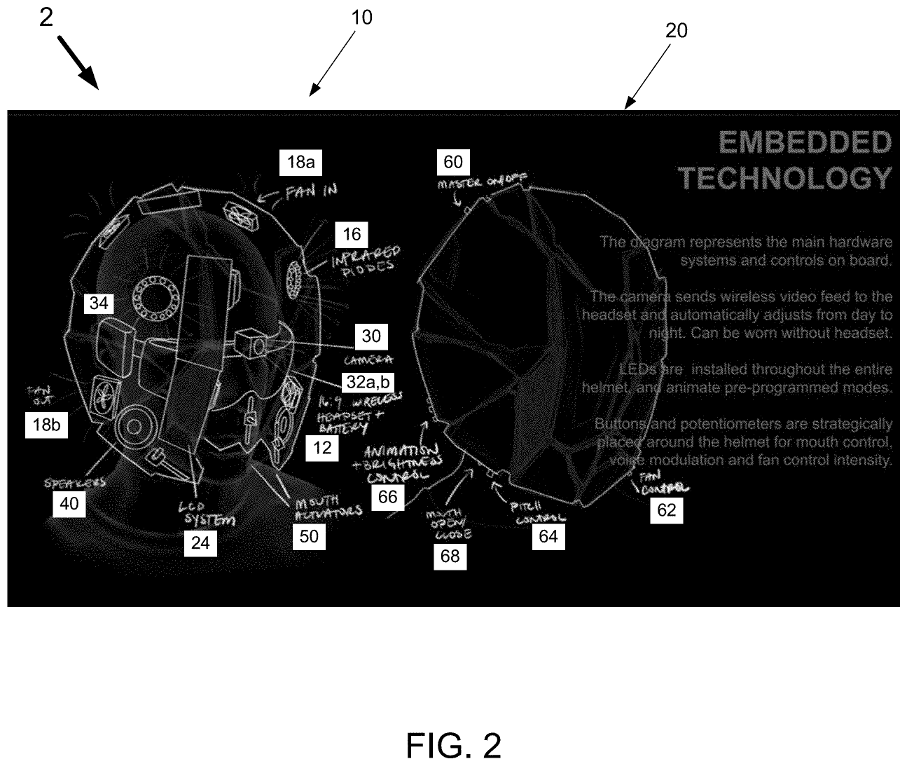

Control may be by voice command of the user. In some embodiments, external controls may be located on the outside of the mask, as seen in FIG. 2. Controls include a master power (on/off) control 60, fan controls 62, pitch controls 64, animation and/or brightness controls 66, and a mouth open/close switch or control 68 (i.e., the user can cause the shell components in the mouth area to open wide enough and stay open to permit the user to eat and/or drink). Control also may be by a device in wireless communication with the mask, such as an application operating on a user mobile computing device (e.g., smartphone, tablet, and the like), or a website on a network, such as the Internet.

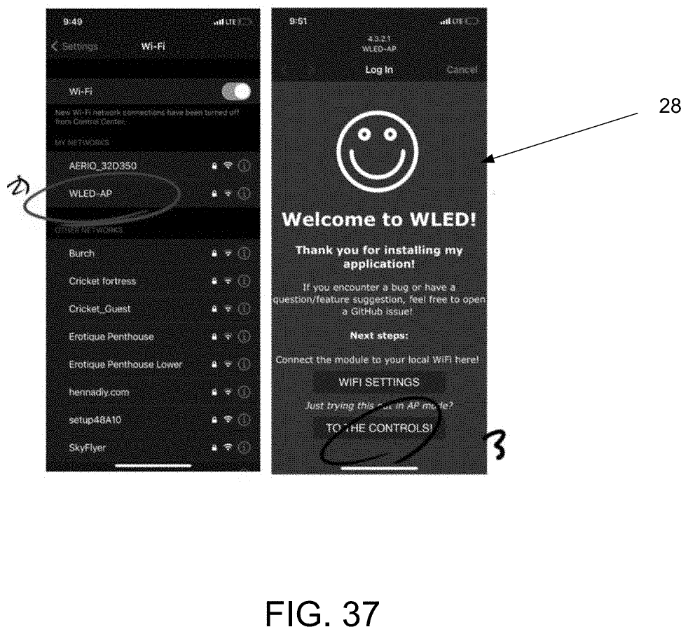

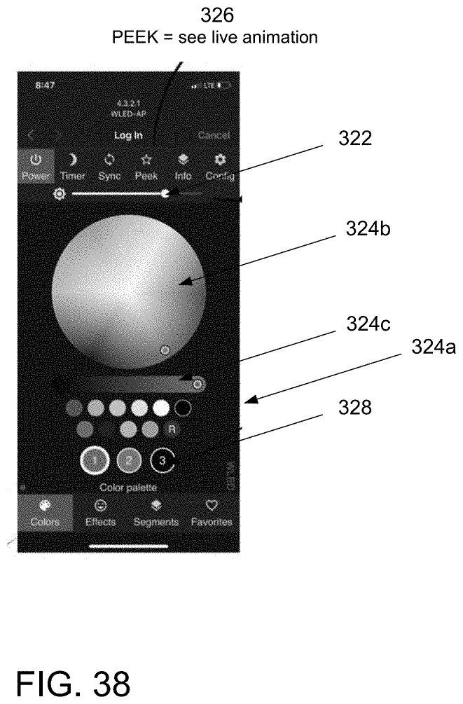

FIGS. 37-40 shows examples of screens from a mobile device application used in conjunction with the mask and associated clothing of the present invention. The mobile device can be clipped into the chest or other pocket of a jacket as an item of associated clothing, and can communicate through wired or wireless connection. FIG. 37 shows an example of a log-in screen 310. FIG. 38 shows an example of a color management screen. The screen provides a main brightness control 322, color options 324a, with the ability to choose a specific color from a color wheel 324b, along with adjusting hue and/or intensity 324c, and the “peek” option 326, which allows the user to see a live animation. In one exemplary embodiment, each animation uses one to three colors, with the user's selection shown in the three numbered circles 328.

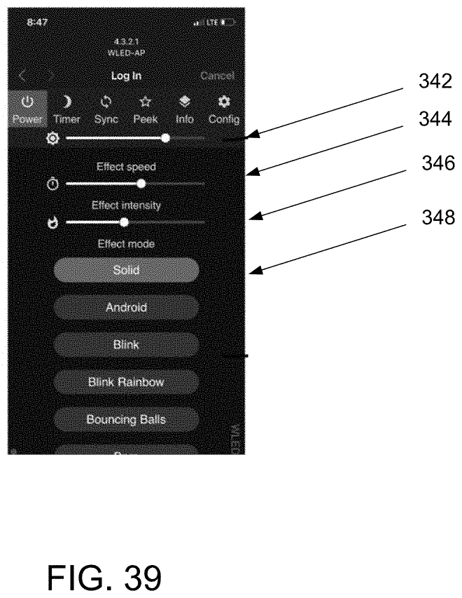

FIG. 39 shows an example of an effects management screen. Controls include brightness 342, effect speed 344, effect intensity 346, and effect mode 348 (e.g., solid, android, blink, blink rainbow, bouncing balls, etc.).

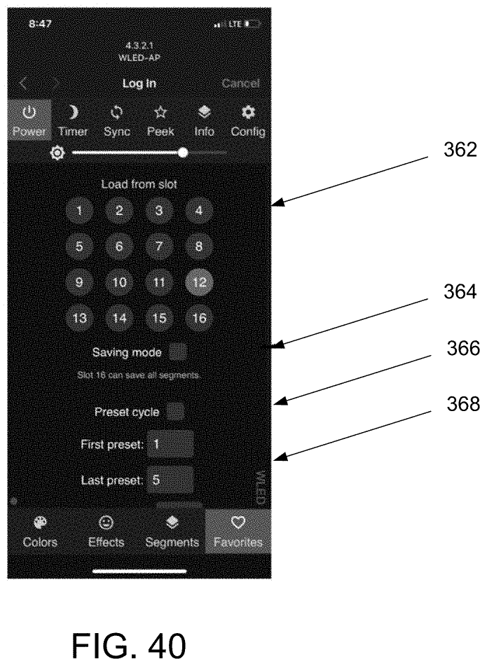

FIG. 40 shows an example of a configuration pre-sets management screen. Controls include the option to load a pre-set from a particular slot 362 (16 slots are provided in the embodiment shown). With the saving mode 364 selected, the current configuration is saved in the slot selected. The present can be cycled 366, and the first and last pre-sets entered 368.

The mask may be transported or kept in a box or similar container 80 for protection when not in use. The container may include ports for connecting the mask to a battery or power source in the container, or to an external power source. The mask or components thereof may be conveniently recharged when not in use.

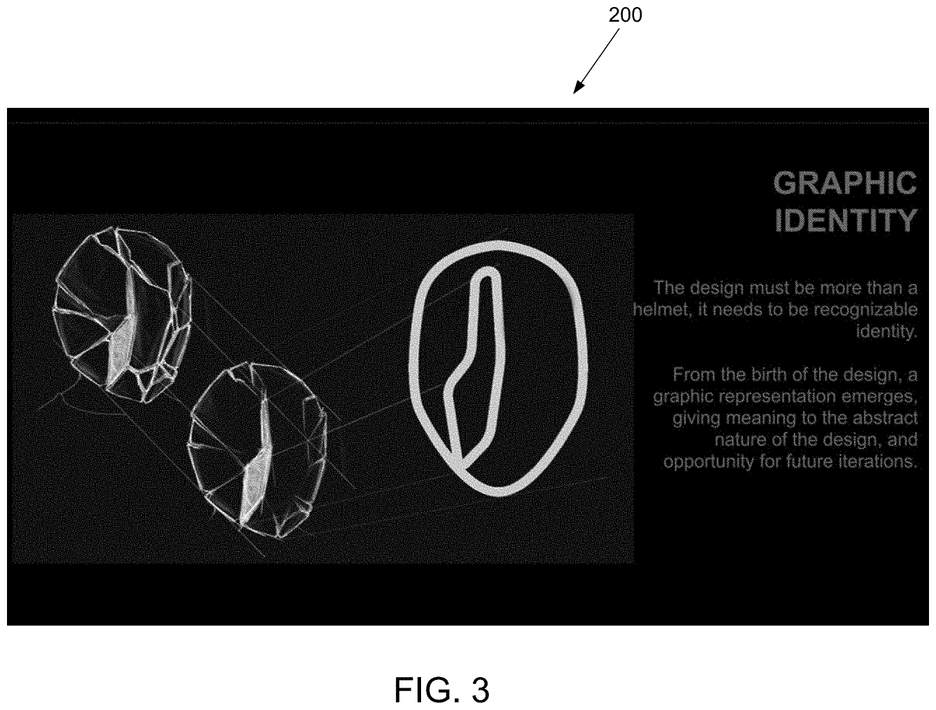

The mask can be programmed to display different colors and effects to provide different looks as part of a “graphic identity” 200, as seen in FIG. 3. The mask may be worn with a variety of electronically-enhanced clothing, costumes, apparel or accessories, which may include, but are not limited to, shoes, boots, socks, jackets, shirts, pants, shorts, ties, bracelets, watches, necklaces, rings, jewelry, sunglasses, glasses, bags, backpacks, purses, luggage, belts, chains, scarves, hats, caps, cuff links, dresses, skirts, furniture, sweaters, hoodies, sweatshirts, underwear, lingerie, gloves, or other items to which one or more electronic components such as cameras, video screens, lights, and/or microphones can be attached. In additional embodiments, accessories may also include appliances, furniture and other home or office furnishings (e.g., toasters, refrigerators, ovens, microwaves, chairs, sofas, desks, tables, and the like). These items may include or comprise one or more microphones, one or more video screens, one or more cameras (e.g., video cameras), one or more light sources, one or more power sources (e.g., batteries), one or more speakers or sound-creating devices, one or more wireless communications chips or devices, and/or one or more microprocessors, CPUs, or processing chips.

Thus, for example, a user “graphic identity” ensemble may include the mask described above, along with a shirt, a jacket, pants or leggings, and shoes or boots, each of the latter items with one or more video screens, light sources, speakers, microphones, and other electronic elements described above, all of which display a similar light and/or animation display, at a minimum.

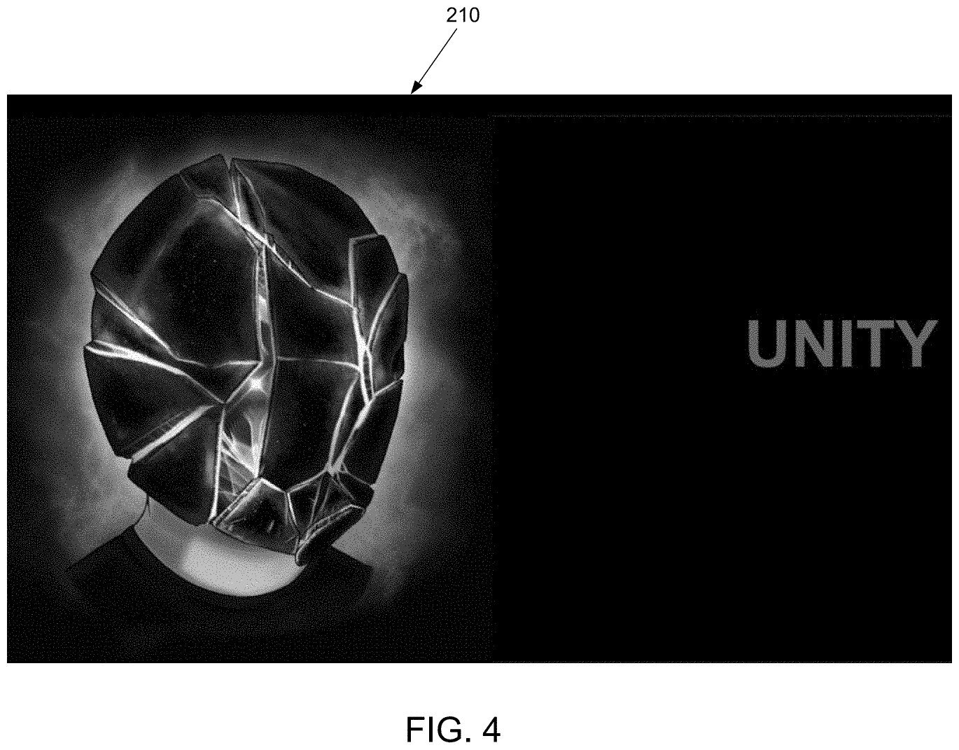

In several embodiments, the mask and/or electronically-enhanced clothing, costumes, apparel and/or accessories may be provided with a number of pre-set or pre-established appearances or aesthetic configurations, which can be changed at any time by the user using an application on a mobile computing device, a website on a network (such as the Internet), a separate dedicated control module, or controls on or in the helmet or item. Controls may be physical buttons, sliders or dials (or similar mechanical controls), touchscreen input, or vocal commands, or combinations thereof. Examples of pre-set aesthetic configurations 210 for a mask are shown in FIGS. 4-8.

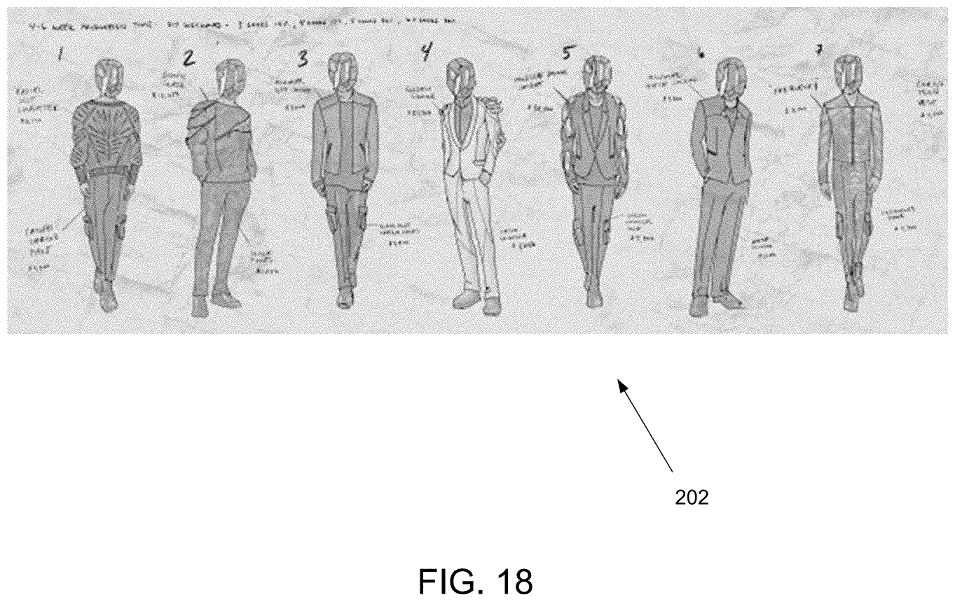

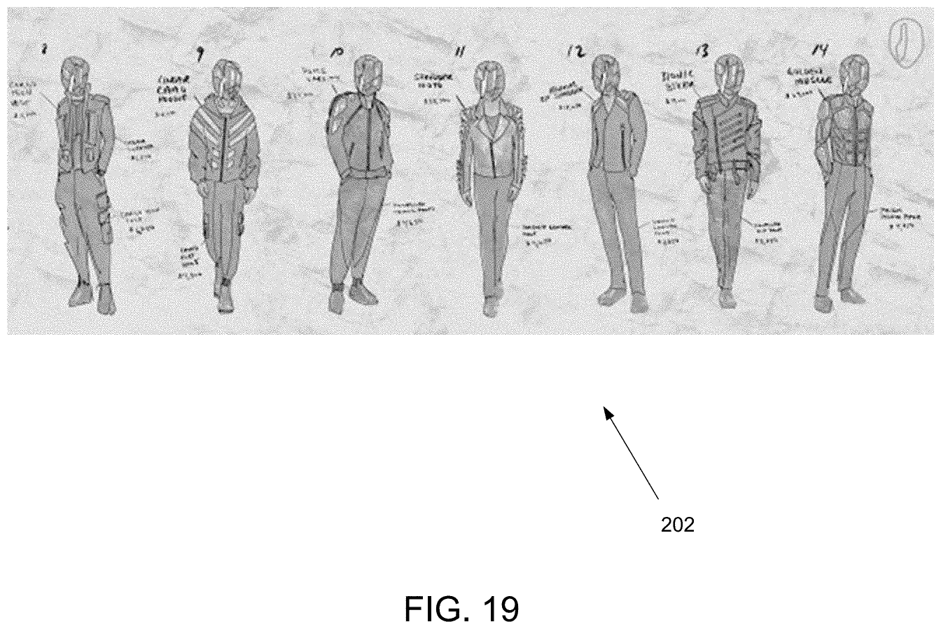

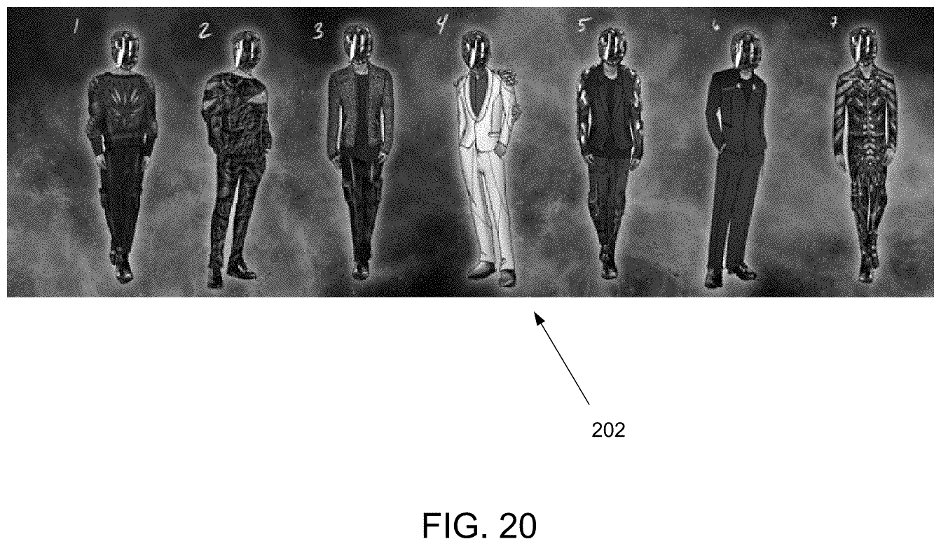

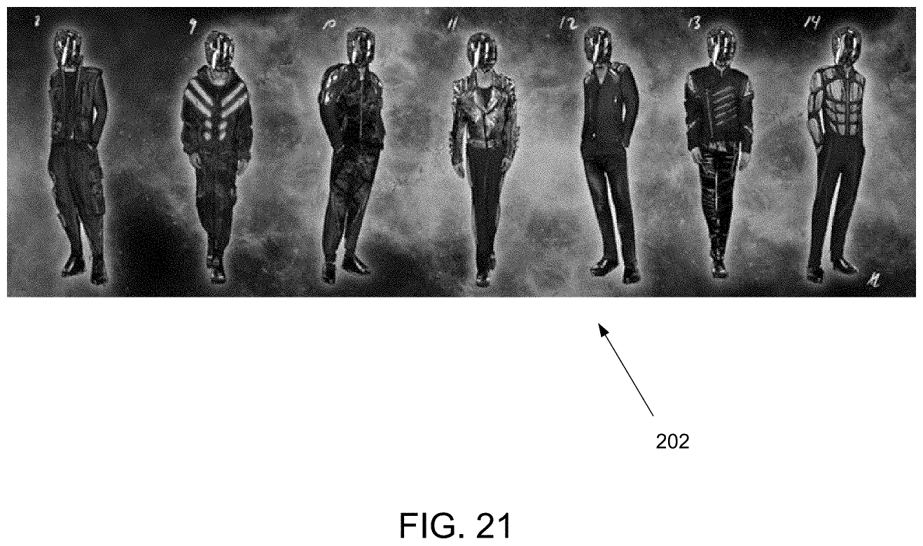

In several embodiments, the mask and electronically-enhanced clothing, costumes, apparel, and/or accessories may be combined to produce a coordinated “graphic identity,” “electronic aesthetic,” or “electronic appearance,” 202 which can be changed by the user as desired. The mask may be in electronic communication, wired or wirelessly, with one or more electronic elements of the clothing, costumes, apparel or accessories. Accordingly, a user can digitally/electronically change his or her appearance or outfit, including any or all of above-described components (e.g., mask, clothing, costume, apparel, accessories) quickly and easily without having to actually change his or her clothes. Illustrative examples of a coordinated graphic identity, electronic aesthetic, or electronic appearance 202 are shown in FIGS. 18-21.

Additional digital pre-set appearance or aesthetic configurations (e.g., “skins”) may also be available (such as by purchasing from a website) for downloading and installing on an individual component, or on multiple components. Several such digital pre-sets may be combined together and provided as a partial or entire package, so that a user may purchase or obtain a partial or complete appearance or configuration change. Further, several such configurations may be provided as a “collection.”

In various exemplary embodiments, some or all of the above-described components (e.g., mask, clothing, costume, apparel, accessories) may comprise one or more microphones attached to or incorporated in the item. In several embodiments, the microphones are directed or positioned to pick up ambient or exterior sounds or noise, such as music. One or more screens and/or light elements (e.g., LEDs) on the item may then produce displays that are synchronized with the ambient or exterior music (or sounds). Where the items are part of an electronic appearance/aesthetic, these displays may be synchronized across all components, although the user also may choose to have only some components synchronized, or none of the components synchronized.

Further, each configuration or “collection” created may provide a different “hardset” way to display the one or more digital preset configurations, as described above, subject to the selection and control by the user. That is, the physical material and appearance of the item surrounding or supporting the various digital and/or electronic components (e.g., video screen, light sources, and the like) may vary from item to item, and collection to collection. Certain digital pre-set appearance or aesthetic configurations (“skins”) may only be available for one or more specific collections. In some embodiments, a user could use the digital skin for a certain “hardset” piece from one collection with a different “hardset” piece from a different collection, and thus compare how the skin looks on various hardset pieces. For example, a user may have one style of shoe where the majority of the surface of the shoe could be a video screen display, while a second style of shoe has smaller screen displays and more of a supporting leather component. A digital skin thus would look different depending on which shoe (i.e., which “hardset” item) it was displayed.

In further embodiments, a “collection” may be expanded to include not only items worn, carried, or accompanying the user (e.g., clothing, worn or carried accessories, and the like), but also items in the home or office space of the user, as described above. Digital skins thus can be applied to appliances, furniture, and/or furnishings.

In several further embodiments, the mobile device application may also be interactive with and in response to real-time events, as well as connecting in real-time to other applications. For example, the user may have their “skins” application connected with their preferred weather application on their mobile device (or with another weather application or service that is compatible with the application). The skins or appearance of some or all of the digital clothing items described above could then automatically change to reflect the real-time weather of the immediate location (or, alternatively, with another chosen location). Thus, if the weather is sunny, the clothing skin will change to match the sunny weather with a sunny or other compatible aesthetic (or, alternatively, another aesthetic chosen by the user). Skins may also reflect the user's immediate or chosen location, environment, mood, or events.

In further embodiments, at least some of the skins are interactive with the user when an article clothing is touched. In one embodiment, skins can be uploaded/downloaded across the system's skins platform, with the skins capable of touch-based interaction.

In yet additional embodiments, the skins platform serves as a platform for creating and marketing of skins and related products as NFTs. An NFT (non-fungible token) is a unit of data stored of a digital ledger (e.g., blockchain) that certifies a digital asset to be unique and thus not interchangeable. NFTs can be used to represent items such as photos, videos, audio, digital files, and digital assets. A user can use the skins application to create and develop skins as NFT digital assets, and thus develop a personal or corporate brand. The system may include a marketplace for skins-related NFTs whereby some, if not all, of the NFTs can be displayed, traded, bought, and sold. In addition to the usual online marketplace formats, users may display the NFTs they own on their own person by projecting the NFTs on their digital clothing, as described above. The projected NFTs may be digital art pieces and not necessarily created for the sole purpose of being an NFT skin offered in the platform marketplace In addition, new skins may be considered as NFTs in and of themselves. In one embodiment, an article of digital clothing may be an NFT itself, and may also be used as a means of displaying and showing off the user's collection of NFTs (e.g., digital art pieces) without having to use a computer or mobile computing device to separately display or show the collected NFTs (e.g., digital art pieces).

In a further embodiment, the digital clothing/skins/art-piece NFTs are augmented reality based, and configured to be projected onto a person or object in the real world through a mobile computing device such as a smart phone, tablet, electronic imaging goggles or face masks, or the like. More specifically, it is an enhanced version of the real, physical world that is achieved through the use of computer-generated perceptual information and elements, which may include multiple sensory modalities, such as visual, sound/auditory, olfactory, somatosensory, haptic, and the like. The computer-generated input is added to or overlaid over real-world imagery, and responds in real time to changes (such as movement) in the real-world environment as reflected in the real-world imagery. The system thus incorporates three basic features: a combination of real and virtual worlds, real-time interaction, and accurate 3D registration of virtual real objects. The NFTs are seamlessly interwoven with the physical world so that the view perceives them as an immersive aspect of the real-world environment.

Thus, for example, a user can create, purchase, or otherwise obtain digital clothing/skins/art-piece NFT and use it to project that NFT onto others around them or on themselves (i.e., “wear” the digital clothing or skin or art-piece). An artist can provide a virtual piece of clothing as an NFT on the system platform marketplace, as described above, as a finite number of pieces (or unlimited, if desired). A fan of that artist could then buy that NFT, which would allow them to use their smart phone or mobile computing device with a camera to then “wear” the NFT, or project it onto others around them.

In order to provide a context for the various computer-implemented aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), tablets, smart phones, touch screen devices, smart TV, internet enabled appliances, internet enabled security systems, internet enabled gaming systems, internet enabled watches; internet enabled cars (or transportation), network PCs, minicomputers, mainframe computers, embedded systems, virtual systems, distributed computing environments, streaming environments, volatile environments, and the like.

Embodiments of the invention may be implemented in the form of computer-executable instructions, such as program code or program modules, being executed by a computer, virtual computer, or computing device. Program code or modules may include programs, objects, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices such as, but not limited to, hard drives, solid state drives (SSD), flash drives, USB drives, optical drives, and internet-based storage (e.g., “cloud” storage).

In one embodiment, a computer system comprises multiple client devices in communication with one or more server devices through or over a network, although in some cases no server device is used. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A graphic identity clothing system, comprising:
an electronic mask with an exterior surface, said exterior surface comprising at least one LCD video screen and two or more polygonal shell components, wherein said shell components are located on the exterior surface to provide a fractured appearance with spaces or gaps between adjacent shell components;
an LED or light source underlayer located underneath the two or more shell components, wherein light from the LED or light source underlayer is visible through the spaces or gaps; and
a controller board with one or more microprocessors, said one or more microprocessors operable to control the color of the LED or light source underlayer, and to control an animation playing on the at least one LCD.

2. The system of claim 1, wherein the electronic mask further comprises:
at least one videocamera;
at least one exterior-facing speaker;
at least one interior sound reproduction device;
a plurality of light sources separate from the LED or light source underlayer;
an interior-facing microphone;
at least one fan; and
a wireless communications module.

3. The system of claim 2, wherein the electronic mask further comprises:
an internal video viewscreen; and
one or more exterior-facing microphones.

4. The system of claim 1, wherein one or more shell components proximate the mouth of a user are movable.

5. The system of claim 1, wherein the exterior surface further comprises one or more of the following controls: a master power control; a fan control; a brightness control; a pitch control; an animation control; and a mouth actuator switch.

6. The system of claim 1, wherein one or more of the shell components is transparent or translucent.

7. The system of claim 1, further comprising:
a container or frame configured to hold a plurality of batteries and be worn on the back of the user, wherein the container is electrically connected to the mask.

8. The system of claim 1, further comprising one or more electronically-enhanced clothing or apparel items, each comprising one or more microphones, one or more video screens, one or more cameras, one or more light sources, one or more power sources, one or more speakers or sound-creating devices, one or more wireless communications chips or devices, and/or one or more microprocessors.

9. The system of claim 8, wherein said one or more electronically-enhanced clothing and/or apparel items are shoes, boots, socks, jackets, shirts, pants, dresses, skirts, shorts, ties, gloves, sweaters, sweatshirts, scarves, lingerie, underwear, hats or caps.

10. The system of claim 8, further comprising one or more electronically-enhanced accessories and/or furnishings, each comprising one or more microphones, one or more video screens, one or more cameras, one or more light sources, one or more power sources, one or more speakers or sound-creating devices, one or more wireless communications chips or devices, and/or one or more microprocessors.

11. The system of claim 10, wherein said one or more electronically-enhanced accessories and/or furnishings are jewelry, watches, cuff links, rings, necklaces, bracelets, purses, bags, backpacks, luggage, belts, chains, home furniture, office furniture, and/or appliances.

12. The system of claim 8, wherein the mask and the electronically-enhanced clothing and/or apparel items are in wireless electronic communication, and combine to produce a coordinated electronic appearance.

13. The system of claim 10, wherein the mask, the electronically-enhanced clothing and/or apparel items, and the electronically-enhanced accessories and/or furnishings are in wireless electronic communication, and combine to produce a coordinated electronic appearance.

14. The system of claim 12, further comprising a plurality of pre-set electronic appearance configurations, wherein the user can change the coordinated electronic appearance by selection of a particular pre-set electronic appearance configuration.

15. The system of claim 12, wherein one or more of said screens or light source elements produces a display synchronized with ambient music or sounds.

16. The system of claim 12, wherein one or more of said screens or light source elements or the coordinated electronic appearance is modified based on the weather, ambient conditions, or events in the user's location or a location chosen by the user.

17. The system of claim 12, wherein one or more of said screens or light source elements or the coordinated electronic appearance is modified when physically touched.

18. The system of claim 12, where one or more elements of a particular pre-set electronic appearance configuration is a non-fungible token.

19. The system of claim 12, further comprising one or more non-fungible tokens, wherein said one or more visual or audio digital assets.

20. The system of claim 19, wherein said one or more visual or audio digital assets are configured to be displayed on or projected onto said mask, one of said electronically-enhanced clothing and/or apparel items, one of said electronically-enhanced accessories and/or furnishings, or a person or object viewed in augmented reality through the mask, a mobile computing device, or electronic imaging goggles.

21. The system of claim 12, wherein one or more of said screens or light source elements on an item or the coordinated electronic appearance is controlled remotely by an application program operable to run on a mobile computing device.
